(19) United States
(12) Patent Application Publication
(10) Pub. No.: US 2011/0068648 A1
(43) Pub. Date: Mar. 24, 2011

(54) ENERGY STORAGE AND GENERATION SYSTEM FOR AN ELECTRICALLY POWERED MOTORIZED VEHICLE

(76) Inventor: Anil ANANTHAKRISHNA, Norcross, GA (US)

(21) Appl. No.: 12/729,211

(22) Filed: Mar. 22, 2010

Related U.S. Application Data
(60) Provisional application No. 61/162,238, filed on Mar. 20, 2009.

(51) Int. Cl. H02K 7/02

(52) U.S. Cl. 310/74

(57) ABSTRACT

An energy storage and generation system for an electrically powered motorized vehicle is disclosed. In one embodiment, an energy storage and generation system for an electrically powered motorized vehicle includes a stator having field coils and sensors which are provided on the inner periphery of the stator, and a rotor having permanent magnets with N and S poles arranged alternately in a circumferential direction on the outer periphery to face the field coils and housing batteries of the electrically powered motorized vehicle. The energy storage and generation system also includes a drive control unit connected to the sensors and the field coils for generating magnetic field in the field coils of the stator in response thereto to rotate the rotor. The rotation of the rotor stores rotational kinetic energy due to the dead weight of the plurality of batteries which is used to propel the electrically powered motorized vehicle.

### CLAIMS OF PRIORITY

Benefit is claimed under 35 U.S.C. 119(e) to U.S. Provisional Application Ser. No. 61162238, entitled “FLYWHEEL POWER SYSTEM IN AN ELECTRIC VEHICLE” by Anil Ananthakrishna, filed on Mar. 20, 2009, which is herein incorporated in its entirety by reference for all purposes.

### FIELD OF TECHNOLOGY

Embodiments of the disclosure generally relate to the field of electrically powered motorized vehicles, and more particularly to an energy storage and generation system in an electrically powered motorized vehicle.

### BACKGROUND

The need to conserve non-renewable energy resource and clean-running vehicles has been echoing for many years. This is due to constant increase in gasoline fuel prices, the exhaustion of the gasoline fuel resources and also other environmental effects by internal combustion exhaust. In general, the need to conserve natural resources, to avoid contamination of the environment as well as economic factors, has led to an increasing emphasis on the efficient use of energy, its collection and storage from renewable sources and making pollution-free operation of on road vehicles and other powered equipments. In the automobile industry, many attempts have been made in this regard to develop an effective free-ranging electrically powered motorized vehicle, however, the success rate in achieving the same is very low due to certain limitations.

In a conventional electrically powered motorized vehicle, the use of rechargeable storage batteries restricts the available power output and range of the vehicle due to dead weight of such batteries. Moreover, the costs of batteries are relatively high which in turn increases the cost of the vehicle. Further, the battery life is another concern as it impacts the economy of the battery powered vehicle, as the replacement cost of the battery is another essential factor.

In addition, the conventional flywheels used in the electrically powered motorized vehicles which stores energy mechanically in the form of kinetic energy have low specific energy. There are safety concerns associated with said flywheels due to their high speed rotor and the possibility of it breaking loose and releasing all its energy in an uncontrolled manner. The conventional flywheels are a less mature technology than chemical batteries and the current cost is too high to make them competitive in the market.

However, the flywheels are the best energy storing device which can be employed in regenerative braking systems. The approach conventionally taken has been to add a flywheel device to a drive system is prone to said limitations. In addition, the conventional materials like iron cast, steel and other metal alloys used for manufacturing flywheels and also the coupling of the flywheel separately to the vehicle crankshaft amounts to adding weight to the vehicle. Hence, this may lead to increase in the cost of assembling the vehicle, its maintenance and also decrease in the efficiency.

### SUMMARY

This Summary is provided to comply with 37 C.F.R. §1.73, requiring a summary of the invention briefly indicating the nature and substance of the invention. It is submitted with the understanding that it will not be used to interpret or limit the scope or meaning of the claims.

An energy storage and generation system for an electrically powered motorized vehicle is disclosed. In one aspect, an energy storage and generation system for an electrically powered motorized vehicle includes a stator having field coils and one or more sensors which are provided on the inner periphery of the stator. The energy storage and generation system further includes a rotor having permanent magnets with N and S poles arranged alternately in a circumferential direction on the outer periphery to face the inner periphery of the field coils. Further, rotor houses batteries of the electrically powered motorized vehicle. The plurality of batteries is housed in the rotor for adding a rotational mass to the rotor.

The energy storage and generation system also includes a drive control unit connected to one or more sensors for obtaining feedback information on the magnetic field polarity of the permanent magnets of the rotor and to the field coils for generating magnetic field in the field coils of the stator in response thereto to rotate the rotor. The rotation of the rotor stores rotational kinetic energy due to the dead weight of the plurality of batteries which is applied to the power wheels of the electrically powered motorized vehicle to propel the electrically powered motorized vehicle.

In another aspect, a flywheel assembly for generating a rotational kinetic energy using a plurality of batteries of an electrically powered motorized vehicle includes a shaft defining an axis of rotation, and a fixed member having field coils and one or more sensors which are provided on the inner periphery of the fixed member. Further, the flywheel assembly includes a rotary member carried on the shaft. The rotary member carries permanent magnets with N and S poles arranged alternately in a circumferential direction on the outer periphery to face the inner periphery of the field coils. The rotary member also houses the plurality of batteries of the electrically powered motorized vehicle. The plurality of batteries is housed in the rotor for adding a rotational mass to the rotor.

The flywheel assembly also includes a drive control unit connected to one or more sensors for obtaining feedback information on a magnetic field polarity of the permanent magnets on the rotary member and to the field coils for generating magnetic field in the field coils of the fixed member in response thereto to rotate the rotary member. The rotation of the rotary member stores rotational kinetic energy due to the dead weight of the plurality of batteries which in turn is applied to the power wheels of the electrically powered motorized vehicle to accelerate the electrically powered motorized vehicle to a speed equal to a predetermined vehicle speed from a standing start.

Other features of the embodiments will be apparent from the accompanying drawings and from the detailed description that follows.

### BRIEF DESCRIPTION OF THE VIEW OF THE DRAWING

FIG. 1 illustrates cross-sectional views of an energy storage and generation system for an electrically powered motorized vehicle, according to one embodiment.

FIG. 2 illustrates a schematic diagram of a combinational system implemented in an electrically powered motorized vehicle, according to one embodiment.

FIG. 3 illustrates a schematic diagram of an exemplary powering system to the combinational system of FIG. 2, according to one embodiment.

The drawings described herein are for illustration purposes only and are not intended to limit the scope of the present disclosure in any way.

### DETAILED DESCRIPTION

An energy storage and generation system for an electrically powered motorized vehicle is disclosed. The following description is merely exemplary in nature and is not intended to limit the present disclosure, applications, or uses. It should be understood that throughout the drawings, corresponding reference numerals indicate like or corresponding parts and features.

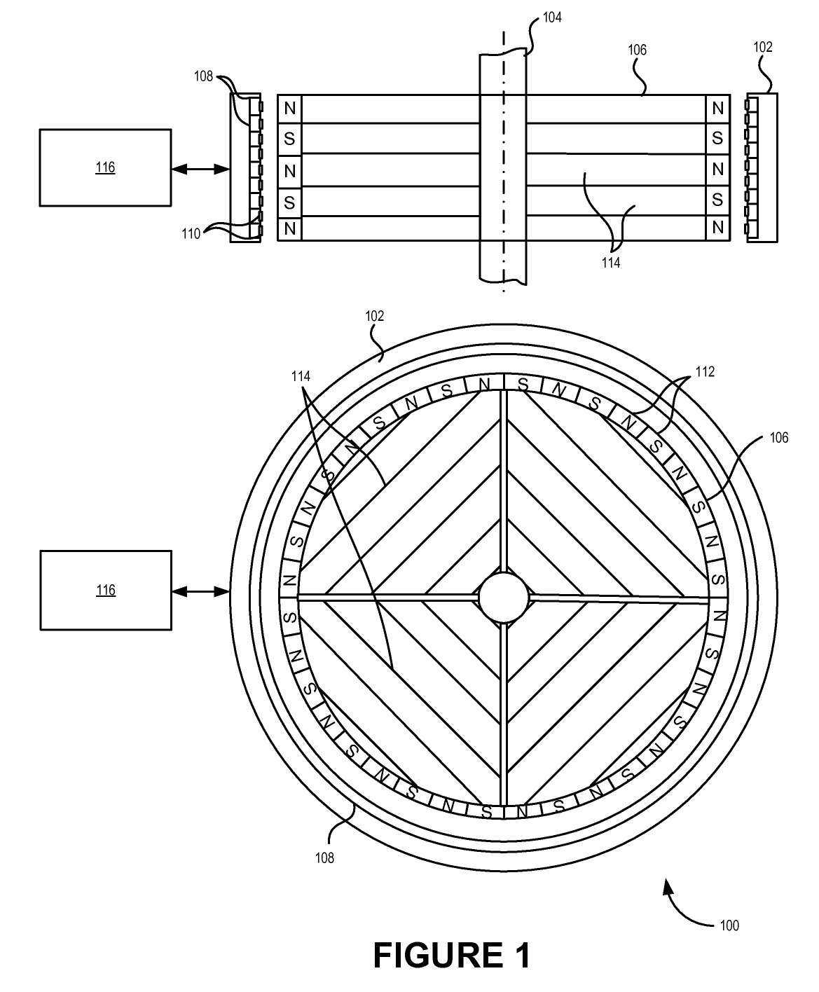

FIG. 1 illustrates cross-sectional views of an energy storage and generation system 100 for an electrically powered motorized vehicle, according to one embodiment. The energy storage and generation system 100 includes a stator 102, a shaft 104, a rotor 106 carried on the shaft 104, and a drive control unit 116. The stator 102 consists of field coils 108 provided on the inner periphery of the stator 102. The stator 102 is mounted on the chassis of the electrically powered motorized vehicle and may be electric powered.

The rotor 106 consists of permanent magnets 112 with N and S poles arranged alternately in a circumferential direction on the outer periphery of the rotor 106 to face the inner periphery of the field coils 108. The inner portion of the rotor 106 houses batteries 114 for the electrically powered motorized vehicle. For example, the batteries 114 may be single chemistry batteries or hybrid chemistry batteries which stores chemical potential energy. The batteries 114 housed by the rotor 106 are having predetermined geometrical shapes and dimensions in order to achieve an agglomerate mass. This agglomerate mass contributes to the rotating mass of the rotor 106.

The stator 102 and the rotor 106 are mounted on a common axis. Further, the rotor 106 is mounted for rotation within the stator 102 in such a way that the field coils 108 of the stator 102 encircle the permanent magnets 112 of the rotor 106. In the energy storage and generation system 100, sensors 110 are placed in a fixed position on the inner periphery of the stator 102 and adjacent to the path of rotation of the rotor 106 for sensing alignment of N and S poles of the permanent magnets 112 of the rotor 106 with the field coils 108 of the stator 102. For example, the sensors 110 may be optical sensors or magnetic sensors of a Hall effect type.

The sensors 110 are coupled to the drive control unit 116 for providing feedback information of the magnetic field polarity of the permanent magnets 112 on the rotor 106. The magnetic field polarity of the permanent magnets 112 is determined based on the alignment of the N and S poles with the field coils 108 of the stator 102. The drive control unit 116 is connected to the field coils 108 for generating magnetic field in the field coils 108 based on the signals from the sensors 110. The magnetic field in the field coils 108 results in commutation of the permanent magnets on the rotor 112 thereby rotating the rotor 106. The drive control unit 116 and the field coils 108 are powered using the power supplied by an external power source or the batteries 114. The external power source may be a power grid connected to a 110, 220V wall socket with suitable power converters.

In operation, the drive control unit 116 rotates the rotor 106 up to a predetermined maximum vehicle speed by energizing the field coils 108 of the stator 102. Once the predetermined maximum vehicle speed is attained, the electric power is cut-off, thereby allowing the rotor 106 to free wheel. The rotor 106 free wheels for longer period of time due to the dead weight of the batteries 114, thereby storing large amounts of rotational kinetic energy.

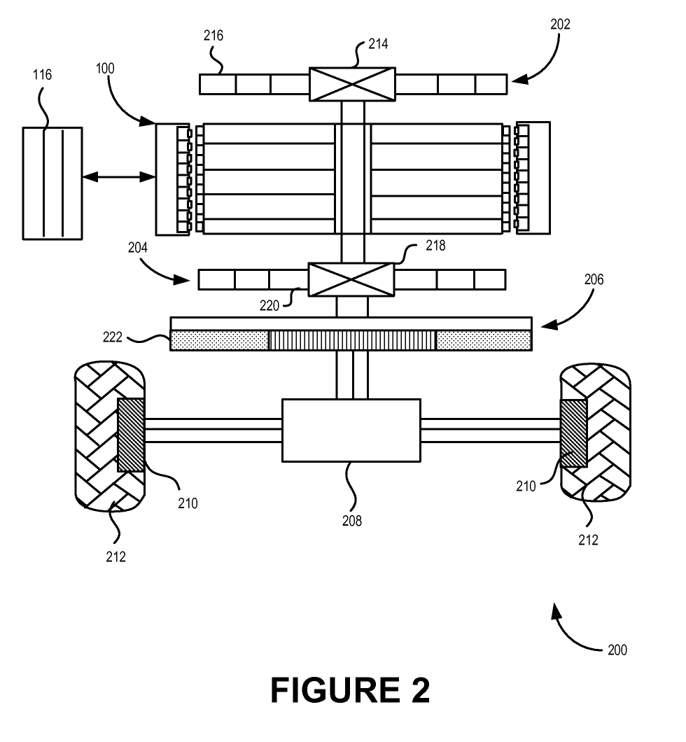

The rotational kinetic energy stored in the spinning rotor 106 is utilized to overcome inertial forces and to propel the electrically powered motorized vehicle. In other words, the rotational kinetic energy thus stored supplies tremendous amount of initial torque to the power wheels to accelerate the electrically powered motorized vehicle to a predetermined vehicle speed from the standing start. It is appreciated that, the rotational kinetic energy is transformed to a transmission system (e.g., a fixed ratio transmission system or a continuously variable transmission system) and then to the power wheels via a differential mechanism as will be illustrated in FIG. 2.

The rotational kinetic energy generated using the dead weight of the batteries 114 eliminates need for instantaneous starting current required for acceleration and thus conserves the chemical potential energy of the batteries 114. Thus, the energy storage and generation system 100 described herein serves to absorb the peak power requirements, thereby leveling the load on the batteries 114.

Once speed of the electrically powered motorized vehicle becomes equal to the predetermined vehicle speed, the chemical potential energy from the batteries 114 is supplied to drive the electrically powered motorized vehicle. Further, the stator 102 and the rotor 106 can also function as a generator mechanism with required electrical and electronic circuitry configured within the drive control unit 116. In one embodiment, when the rotor 106 is spinning without being connected to provide output mechanical traction, the generator mechanism may generate electrical power. The electric powered thus generated by the generator mechanism can be used to recharge the batteries 114.

In another embodiment, when the electrically powered motorized vehicle is intended to reduce speed, the generator mechanism depletes the kinetic energy from the rotor 106 and generates electric power which in turn recharges the batteries 114. In other words, the generator mechanism generates electrical power based on inertia of the power wheels generated on requirement of reducing speed and hence stores chemical potential energy in the batteries using the electrical power. It can be noted that, during operation of the electrically powered motorized vehicle, when the rotor 106 is up to speed, the rotational kinetic energy is primarily applied to the power wheels for propulsion rather than to charge the batteries 114 using the generator mechanism.

FIG. 2 illustrates a schematic diagram of a combinational system 200 implemented in an electrically powered motorized vehicle, according to one embodiment. The combinational system 200 includes the energy storage and generation system 100, drag and draw compensation mechanisms 202 and 204, a clutch actuation mechanism 206, a transmission system and differential mechanism 208, and an electric hub motor 210 in power wheels 212.

As shown in FIG. 2, the rotational kinetic energy stored in the energy storage and generation system 100 is transmitted to the electric hub motor 210 in the power wheels 212. The rotational kinetic energy to the electric hub motor 210 is transmitted through the clutch actuation mechanism 206 and the transmission system and differential mechanism 208 as will be described in greater detail below.

The energy storage and generation mechanism 100 is coupled to a set of drag and draw compensation actuators 214 and 218 which consists of the drag and draw compensation plates 216 and 220 on either sides. The drag and draw compensation actuator 218 is coupled to the clutch actuation mechanism 206. The clutch actuation mechanism 206 can be electric powered, hydraulic powered or pneumatic powered and is connected to the clutches 222. The clutches 222 are connected to the differential gears through a continuous variable transmission system or a fixed ratio transmission system.

The combinational hybrid of the transmission system and differential mechanism 208 and the electric hub motor 210 is embedded in the power wheels 212 to maximize regenerative braking and cope with road load requirements while driving. The transmission system and differential mechanism 208 is made up of gears, belts, pulleys, spheres, hydraulic system, or pneumatic system embedded into any or all the power wheels 212 of the electrically powered motorized vehicle or mounted separately and connected to the driven power wheels.

In general, the combinational system 200 provides power to the electrically powered motorized vehicle using the transmission system and differential mechanism 208. It is appreciated that, the transmission system and differential mechanism 208 provides multiple torque ratios at varied gradients and load conditions so that the torque and speed of the electrically powered motorized vehicle are maintained at optimal levels. It can be noted that, the batteries 114 in the rotor 106 are supported through a dynamic stabilizing platform that takes care of drag and draw forces of the energy storage and generation system 100.

The drag and draw forces may occur when there is a change in directional path of the electrically powered motorized vehicle. The drag and the draw compensation mechanisms 202 and 204 contain ball bearings, spheres and rollers with dampers to achieve stabilization by controlling the drag and draw forces. In one embodiment, the combinational system 200 achieves stabilization by positioning the drag and draw compensation plates 216 and 220 in the desired position of opposition to control draw or drag forces. The combinational system 200 thus optimizes energy surge requirements during an initial startup of the electrically powered motorized vehicle.

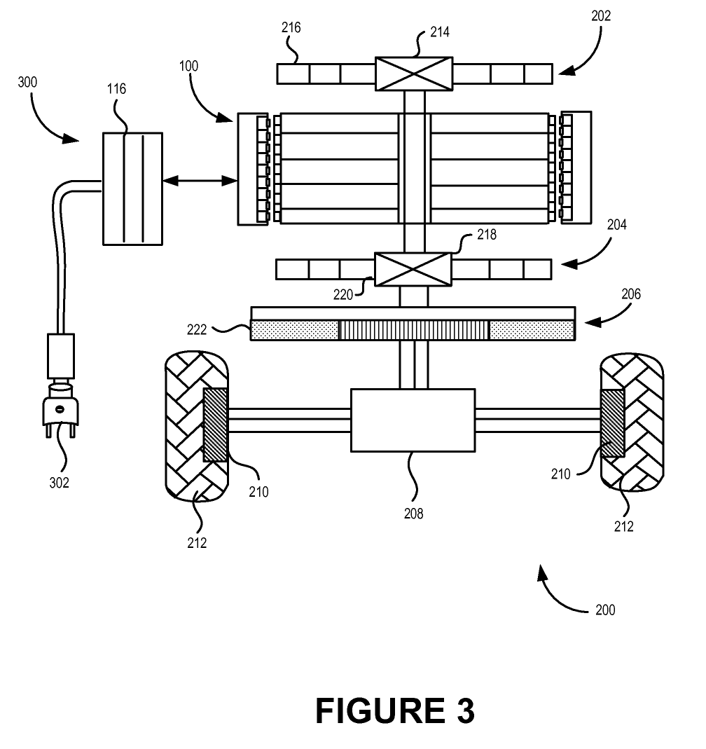

FIG. 3 illustrates a schematic diagram of an exemplary powering system 300 to the combinational system 200 of FIG. 2, according to one embodiment. When the electrically powered motorized vehicle is stand still, the drive control unit 116 is powered initially by a power grid 302 which is connected to a 110, 220 V wall socket with suitable power converters. Using this power, the rotor 106 is being rotated till a predetermined vehicle speed is attained. As described above, the rotor 106 containing the batteries 114 is then allowed to free wheel.

As a result of free wheeling, the rotor 106 stores a large amount of rotational kinetic energy due to dead weight of the batteries 114. The rotor 106 acts as a flywheel utilizing the battery mass and store large amounts of rotational kinetic energy as well as chemical potential energy. The rotational kinetic energy is utilized for initial propulsion of the electrically powered motorized vehicle. For instance, an electric car may be propelled forward by releasing the clutch and transferring the kinetic energy from the flywheel to power wheels 212 of the car.

It can be noted that, initial propulsion of the electrically powered motorized vehicle may not drain the batteries 114, instead would use the rotational kinetic energy stored using the mass of the batteries 114. Thus, the high instantaneous starting current normally required for acceleration would be avoided and improve the battery performance. The utilization of the kinetic energy during initial start up eliminates the power requirements from the batteries 114 which aids in maintaining the batteries 114 from discharging of heavy currents in a short span of time.

One can envision that, the above-described energy storage and generation system 100 can be implemented as a flywheel assembly in the electrically powered motorized vehicle for storing kinetic energy using the dead weight of the batteries and chemical potential energy of the batteries. Also, one can envision that, the above-described energy storage and generation system 100 can be used in any motive power application.

In various embodiments, the energy storage and generation system 100 described in FIGS. 1 through 3 enables storing of rotational kinetic energy and chemical potential energy. Thus, the combinational system 200 helps optimize energy storage for a pure electric drive and integrated electric hybrids. The combinational system 200 also helps optimize energy surge requirements during an initial startup of the electrically powered motorized vehicle. Further, the powering of the field coils 108 of the stator 102 at appropriate required conditions helps maintain the battery performance at optimum levels. Moreover, in the energy storage and generation system 100, it is possible to withdraw large amount of energy in a far shorter time than with traditional chemical batteries.

The above-described energy storage and generation system 100 have high turn-around efficiency and the potential for very high specific power compared with the batteries. In addition, the above-described energy storage and generation system 100 have very high output potential and relatively long life and are relatively unaffected by temperature extremes.

It will be recognized that the above described invention may be embodied in other specific forms without departing from the spirit or essential characteristics of the disclosure. Thus, it is understood that, the invention is not to be limited by the foregoing illustrative details, but it is rather to be defined by the appended claims.

What is claimed is:

1. An energy storage and generation system for an electrically powered motorized vehicle comprising:
a stator having field coils and one or more sensors which are provided on the inner periphery of the stator;
a rotor having permanent magnets with N and S poles arranged alternately in a circumferential direction on the outer periphery to face the field coils and housing a plurality of batteries of the electrically powered motorized vehicle, wherein the plurality of batteries add rotating mass to the rotor; and
a drive control unit connected to the one or more sensors for obtaining feedback information on a magnetic field polarity of the permanent magnets on the rotor and to the field coils for generating magnetic field in the field coils of the stator in response thereto to rotate the rotor, wherein the rotation of the rotor stores rotational kinetic energy due to the dead weight of the plurality of batteries, and wherein the rotational kinetic energy is applied to the power wheels of the electrically powered motorized vehicle to propel the electrically powered motorized vehicle.

2. The system of claim 1, wherein the field coils of the stator encircle the permanent magnets of the rotor, and wherein the stator and the rotor are mounted on a common axis, and wherein the rotor is mounted for rotation within the stator.

3. The system of claim 2, wherein the drive control unit generates magnetic field in the field coils of the stator based on a signal generated by the one or more sensors, and wherein the signal is generated based on alignment of the N and S poles of the permanent magnets of the rotor with the field coils of the stator.

4. The system of claim 3, wherein the field coils of the stator are powered by the drive control unit which is in turn powered by a source selected from the group consisting of an external power source and the plurality of batteries.

5. The system of claim 4, wherein the external power source comprises a power grid with power converters.

6. The system of claim 5, wherein the plurality of batteries housed in the rotor comprises batteries of a predetermined geometrical shape and dimension such that the plurality of batteries adds an agglomerate mass to the rotor.

7. The system of claim 6, wherein the plurality of batteries are selected from the group consisting of single chemistry batteries and hybrid chemistry batteries.

8. The system of claim 1, wherein the rotor transfers the rotational kinetic energy to a transmission system and differential mechanism of the electrically powered motorized vehicle which in turn transforms the kinetic energy of the rotor into rotational energy of the power wheels to propel the electrically powered motorized vehicle.

9. The system of claim 1, wherein the plurality of batteries housed in the rotor are operable for supplying power for driving the electrically powered motorized vehicle when the speed of the electrically powered motorized vehicle is equal to or lower than a predetermined vehicle speed.

10. The system of claim 1, wherein the stator and the rotor together forms a generator mechanism such that the generator mechanism generates electric power using the inertia of the power wheels generated on requirement of reducing speed and recharges the plurality of batteries.

11. The system of claim 1, wherein the plurality of batteries housed in the rotor are supported through a dynamic stabilization platform such that drag and draw effects are compensated during change in directional path of the electrically powered motorized vehicle.

12. The system of claim 11, wherein the dynamic stabilization platform comprises drag and draw compensation plates positioned in a required position of opposition to control the drag and draw effects created due to change in the directional path of the electrically powered motorized vehicle.

13. A flywheel assembly for generating rotational kinetic energy using a plurality of batteries of an electrically powered motorized vehicle comprising:
a shaft defining an axis of rotation;
a fixed member having field coils and one or more sensors placed on the inner periphery of the fixed member;
a rotary member carried on the shaft and having permanent magnets with N and S poles arranged alternately in a circumferential direction on the outer periphery to face the field coils and containing a plurality of batteries of the electrically powered motorized vehicle, wherein the plurality of batteries add rotating mass to the rotary member; and
a drive control unit connected to the one or more sensors for obtaining feedback information on a magnetic field polarity of the permanent magnets on the rotary member and to the field coils for generating magnetic field in the field coils of the fixed member in response thereto to rotate the rotary member, wherein the rotation of the rotary member stores rotational kinetic energy due to the dead weight of the plurality of batteries, and wherein the rotational kinetic energy is applied to the power wheels of the electrically powered motorized vehicle to accelerate the electrically powered motorized vehicle to a speed equal to a predetermined vehicle speed from a standing start.

14. The flywheel assembly of claim 13, wherein the field coils of the fixed member encircle the permanent magnets of the rotary member, and wherein the fixed member and the rotary member are mounted on a common axis, and wherein the rotary member is mounted for rotation within the fixed member.

15. The flywheel assembly of claim 14, wherein the drive control unit generates the magnetic field in the field coils of the stator based on a signal generated by the one or more sensors, and wherein the signal is generated based on alignment of the N and S poles of the permanent magnets of the rotor with the field coils of the stator.

16. The flywheel assembly of claim 15, wherein the rotary member transfers the kinetic energy to a transmission system and differential mechanism of the electrically powered motorized vehicle which in turn transfers the kinetic energy from the rotary member into rotational energy of the power wheels to accelerate the electrically powered motorized vehicle to a predetermined vehicle speed.

17. The flywheel assembly of claim 13, wherein the plurality of batteries housed in the rotary member comprises batteries of a predetermined geometrical shape and dimension such that the plurality of batteries adds an agglomerate mass to the rotary member.

18. The flywheel assembly of claim 17, wherein the plurality of batteries are selected from the group consisting of single chemistry batteries and hybrid chemistry batteries.

19. The flywheel assembly of claim 18, wherein the plurality of batteries housed in the rotary member are operable for supplying power for driving the electrically powered motorized vehicle when the speed of the electrically powered motorized vehicle is equal to or lower than the predetermined vehicle speed.

20. The flywheel assembly of claim 13, wherein the fixed member and the rotary member together forms a generator mechanism such that the generator mechanism generates electric power using the inertia of the power wheels generated on requirement of reducing speed and recharges the plurality of batteries.
